(19) United States
(12) Patent Application Publication
(10) Pub. No.: US 2025/0199499 A1
(43) Pub. Date: Jun. 19, 2025

(54) SYSTEMS AND METHODS FOR DYNAMICALLY CUSTOMIZING A MANUFACTURING PROCESS USING OBJECT-ORIENTED PROGRAMMING

(71) Applicant: SIMPLICONTROL, INC., Clarkston, MI (US)

(72) Inventors: Andrew Derbyshire, Goodrich, MI (US); Shawn Gutierrez, Clarkston, MI (US); Scott Selvidge, Clinton Township, MI (US)

(21) Appl. No.: 18/901,371

(22) Filed: Sep. 30, 2024

Related U.S. Application Data
(60) Provisional application No. 63/610,599, filed on Dec. 15, 2023.

(51) Int. Cl. G05B 19/05

(52) U.S. Cl. CPC G05B 19/056; G05B 19/054; G05B 2219/1159

(57) ABSTRACT

A method includes generating a manufacturing area table based on at least one area parameter associated with a manufacturing area of the manufacturing environment, generating a plurality of OOP-based collections based on state data associated with the manufacturing area and the manufacturing area table, storing the manufacturing area table and the plurality of OOP-based collections in a relational database, and selecting a target manufacturing process from among the plurality of manufacturing processes. The method includes, for each step of the manufacturing process, selecting, based on the manufacturing area, an image and a fixture indicator that are stored in the relational database, assigning at least one target OOP-based collection to the step based on at least one step parameter, and generating an object from among a plurality of objects stored in the relational database based on the image, the fixture indicator, and the at least one target OOP-based collection.

### CROSS-REFERENCE TO RELATED APPLICATION

This application claims priority to U.S. provisional application No. 63/610,599 filed on Dec. 15, 2023. The disclosure of the above application is incorporated herein by reference.

### FIELD

The present disclosure relates to systems and methods for customizing a manufacturing process.

### BACKGROUND

The statements in this section merely provide background information related to the present disclosure and may not constitute prior art.

In a manufacturing environment, programmable logic controllers (PLCs) and human machine interfaces (HMIs) may be provided at various workstations to collectively control and visualize manufacturing processes for a given article (e.g., a vehicle component, electronic devices, etc.). As an example, a PLC controls and automates various manufacturing processes by monitoring input devices (e.g., sensors, switches, instrumentation devices, etc.) and executing instructions to cause a manufacturing transformation machine (e.g., a machining tool, a burning/welding machine, a computer numerical control (CNC) machine, a chemical machining tool, an electrical machining tool, etc.) to perform one or more operations. As another example, a given application state of the HMI may display text and other user interface elements configured to instruct a user to load workpieces onto a fixture (e.g., a uniaxial locator, a biaxial locator, and/or a planar locator), verify that the workpiece is aligned with the fixture, and control the PLC to initiate a manufacturing transformation on the workpiece.

In some embodiments, a programmer may initially perform a PLC mapping routine to enable the PLC functionality described herein. As used herein, the “PLC mapping routine” refers to a routine in which PLC inputs and outputs are associated with specific addresses or variables of a nontransitory computer-readable medium (NCRM) of the PLC. The PLC mapping routine may be performed by manually associating addresses/variables to various input and output devices or by automatically associating addresses/variables that are identified during a scanning routine of the NCRM of the PLC.

As an example, in complex or distributed manufacturing environments (i.e., a manufacturing environment comprising various manufacturing areas having respective components that are communicably coupled to each other), a plurality of PLCs may be implemented to monitor and control the specialized and complex functionality of various manufacturing areas. As such, various issues during the PLC mapping routine may inhibit the performance of the PLCs and, more specifically, the capability to control various manufacturing processes. Specifically, incorrect addressing, data types, hardware configuration, scaling, and communication mapping (e.g., mapping between different types of PLCs and/or PLCs having different communication protocols) may inhibit one or more of the PLCs from accurately monitoring and controlling associated manufacturing processes.

### SUMMARY

This section provides a general summary of the disclosure and is not a comprehensive disclosure of its full scope or all of its features.

The present disclosure provides a method for defining a plurality of manufacturing processes of a manufacturing environment using an object-oriented programming (OOP) routine. The method includes generating a manufacturing area table based on at least one area parameter associated with a manufacturing area of the manufacturing environment, generating a plurality of OOP-based collections based on state data associated with the manufacturing area and the manufacturing area table, storing the manufacturing area table and the plurality of OOP-based collections in a relational database, and selecting a target manufacturing process from among the plurality of manufacturing processes. The method includes, for each step of the manufacturing process, selecting, based on the manufacturing area, an image and a fixture indicator that are stored in the relational database, assigning at least one target OOP-based collection from among the plurality of OOP-based collections to the step based on at least one step parameter associated with the step, and generating an object from among a plurality of objects stored in the relational database based on the image, the fixture indicator, and the at least one target OOP-based collection.

In some embodiments of the method of the above paragraph, which may be implemented individually, in combination, or at least partly in combination: the manufacturing area table, the plurality of OOP-based collections, and the object are generated by a client computing device; the method includes controlling, by a programmable logic controller, the target manufacturing process; the at least one area parameter comprises at least one a workspace parameter and an output device parameter; the output device parameter comprises at least one of a type of a robot, a size of the robot, an operating range of the robot, and a degree of freedom of the robot; the workspace parameter comprises at least one of a manufacturing area dimension and a manufacturing area type; the output device parameter comprises at least one of an object type, an object size, and an object location within the manufacturing area; the at least one area parameter is based on a programmable logic controller simulation file; the state data comprises at least one of sensor data associated with a sensor of the manufacturing environment and controller data associated with a programmable logic controller of the manufacturing environment; the method includes generating and storing at least one additional table in the relational database, where the at least one additional table comprises at least one of a manufacturing process table, a collections table, a scalable vector graphic table, and a workpiece image table; the manufacturing area table and the at least one additional table define a one-to-many relationship; the method includes generating and storing a manufacturing step table in the relational database, where the at least one additional table comprises the manufacturing process table, and where the manufacturing process table and the manufacturing step table define a one-to-many relationship; the method includes generating and storing a fixture indicator table in the relational database, where the at least one additional table comprises the collections table and the scalable vector graphic table, where the fixture indicator table and the collections table define a one-to-one relationship, and where the fixture indicator table and the scalable vector graphic table define the one-to-one relationship; the fixture indicator table indicates an arrangement of at least one fixture indicator of the manufacturing environment; the at least one additional table comprises the collections table, and the manufacturing area table and the collections table define a one-to-many relationship; the at least one step parameter comprises at least one of a prerequisite collection parameter, a command parameter, and a completion parameter; and/or generating the object further comprises performing a relational operation on the image, the fixture indicator, and the at least one target OOP-based collection.

The present disclosure provides a system for defining a plurality of manufacturing processes of a manufacturing environment using an object-oriented programming (OOP) routine. The system includes a processor and a nontransitory computer-readable medium comprising instructions that are executable by the processor. The instructions include generating a manufacturing area table based on at least one area parameter associated with a manufacturing area of the manufacturing environment, generating a plurality of OOP-based collections based on state data associated with the manufacturing area and the manufacturing area table, storing the manufacturing area table and the plurality of OOP-based collections in a relational database, and selecting a target manufacturing process from among the plurality of manufacturing processes. The instructions include, for each step of the manufacturing process, selecting, based on the manufacturing area, an image and a fixture indicator that are stored in the relational database, assigning at least one target OOP-based collection from among the plurality of OOP-based collections to the step based on at least one step parameter associated with the step, and generating an object from among a plurality of objects stored in the relational database based on the image, the fixture indicator, and the at least one target OOP-based collection.

The present disclosure provides a method for controlling a plurality of manufacturing processes of a manufacturing environment. The method includes generating and storing, by a client computing device, a plurality of objects in a relational database based on an object-oriented programming (OOP) routine; mapping, by a programmable logic controller (PLC), the plurality of objects of the relational database to a nontransitory computer-readable medium of the PLC; and executing, by the programmable logic controller, instructions having a PLC-based syntax to control one or more output devices associated with the plurality of manufacturing processes, where the control of the one or more output devices is based on the plurality of objects.

In some embodiments of the method of the above paragraph, which may be implemented individually, in combination, or at least partly in combination: the method includes obtaining a first input associated with a selection of a target manufacturing process from among the plurality of manufacturing processes and a manufacturing area of the manufacturing environment, querying a relational database based on the first input to identify a target object from among a plurality of objects stored in the relational database, where the target object is associated with the target manufacturing process, displaying a plurality of graphical user interface (GUI) elements associated with the target object, and selectively adjusting a step parameter of a step of the target manufacturing process in response to a selection of at least one of the GUI elements from among the plurality of GUI elements; the method includes displaying the plurality of GUI elements based on state data associated with the target manufacturing process, where the state data comprises at least one of sensor data associated with a sensor of the manufacturing environment and controller data associated with a programmable logic controller of the manufacturing environment; the method includes displaying the plurality of GUI elements based on at least one area parameter associated with the target manufacturing process, where the at least one area parameter comprises at least one of a robot parameter, a workspace parameter, and an object parameter; and/or the at least one step parameter comprises at least one of a prerequisite collection parameter, a command parameter, and a completion parameter.

The present disclosure provides a method for controlling a plurality of manufacturing processes of a manufacturing environment, the method comprising: mapping, by a programmable logic controller (PLC), a plurality of objects that are stored in a relational database to a nontransitory computer-readable medium of the PLC; and executing, by the programmable logic controller, instructions having a PLC-based syntax to control one or more output devices associated with the plurality of manufacturing processes, wherein the control of the one or more output devices is based on the plurality of objects.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a functional block diagram of a manufacturing control system in accordance with the teachings of the present disclosure;

FIG. 2 illustrates a functional block diagram of a client computing device in accordance with the teachings of the present disclosure;

FIG. 3 illustrates a functional block diagram of a relational database in accordance with the teachings of the present disclosure;

FIG. 4 is a flowchart of an example routine for defining a plurality of manufacturing processes of a manufacturing environment in accordance with the teachings of the present disclosure; and

FIG. 5 is a flowchart of an example routine for controlling a plurality of manufacturing processes of a manufacturing environment in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Programming logic controllers generally execute source code using syntax from graphical and textual languages identified by the international standard IEC 61131 for PLCs, such as Ladder diagram (LD), Function block diagram (FBD), Structured text (ST), Instruction list (IL), or Sequential function chart (SFC). However, these PLC programming languages generally do not support object-oriented, functional, or concurrent programming schemes, thereby inhibiting the efficiency in which complex source code is efficiently executed and/or complex data structures are efficiently interpreted. As an example, manufacturing processes and/or workpieces may be subjected to several dynamic variations (e.g., variations to a sequence/type of manufacturing processes, custom workpieces and/or custom manufacturing transformations associated with the custom workpieces, among others) that may require increased complexity in source code and/or data processing. As such, the one or more PLCs may not accurately monitor and control associated manufacturing processes that have been subjected to a dynamic variation by, for example, an operator.

These issues with PLC mapping and inefficiencies of executing complex source code and interpreting complex data structures, among other issues, are addressed by the present disclosure.

As described herein, the present disclosure provides systems and methods for defining and controlling a plurality of manufacturing processes of a manufacturing environment that are executed by a PLC and using an object-oriented programming (OOP) routine. Specifically, the system includes a client computing device, a relational database, and a PLC. The client computing device is configured to define various aspects of a manufacturing environment as relational database tables having uniquely defined logical relationships therebetween, such as manufacturing area parameters, workpieces, fixtures, fixture indicators, among other components of the manufacturing area. Specifically, the logical relationships are defined as primary and foreign key pairs that collectively represent various aspects of the manufacturing environment. As used herein, “primary key” refers to a set of columns in a relational database table whose values uniquely identify a row in the table (e.g., an identification number), and “foreign key” refers to a set of columns in a relational database table whose values correspond to the values of the primary key in another table. When the various relational database tables are defined, the client computing device is configured to generate and store objects that represent the complex relationships between the various aspects/components of the manufacturing environment. Subsequently, the PLC mapping routine of the PLC is performed such that the objects of the relational database are mapped to the variables of the PLC.

As such, incorrect addressing, accounting for different data types and hardware configurations, scaling, and communication mapping issues are inhibited. Furthermore, by mapping the objects of the relational database to the PLC, the accuracy in which complex operations and data operations performed by the PLC increases. Specifically, the mapping routine enables the PLC to execute syntax from graphical and textual languages identified by the international standard IEC 61131 for PLCs with the accuracy and efficiency of more complex OOP-based programming languages. That is, OOP-based programming languages generally enable abstraction (e.g., objects are defined to selectively group data elements and methods), encapsulation (e.g., objects selectively provide access to only a set of relevant data elements/methods), inheritance (e.g., newly created classes can reuse instructions from other classes), and polymorphism (e.g., objects can include similar methods and data elements and respond to a message in different manners), which are generally not achievable using syntax from languages identified by the international standard IEC 61131.

As used herein, an “OOP routine” refers to source code that is organized as a plurality of objects that are defined based on one or more classes. In one embodiment, the OOP routine may include source code written using syntax from OOP languages including, but not limited to, Ruby, Scala, JADE, Emerald, Java®, Python®, Visual Basic®, C++, or Smalltalk. As used herein, a “class” refers to a block of source code representing a template for defining objects. As an example, the class defines names, types, ranges, and/or default values of data elements (e.g., attributes) and various operations (e.g., methods) of an object. Example operations include, but are not limited to, manipulation of stored data, control of the HMI and/or other components within the manufacturing environment, and broadcasting a message configured to invoke methods of other objects. As used herein, an “object” refers to an instance of the class and includes defined parameters/values of the data elements and defined operations.

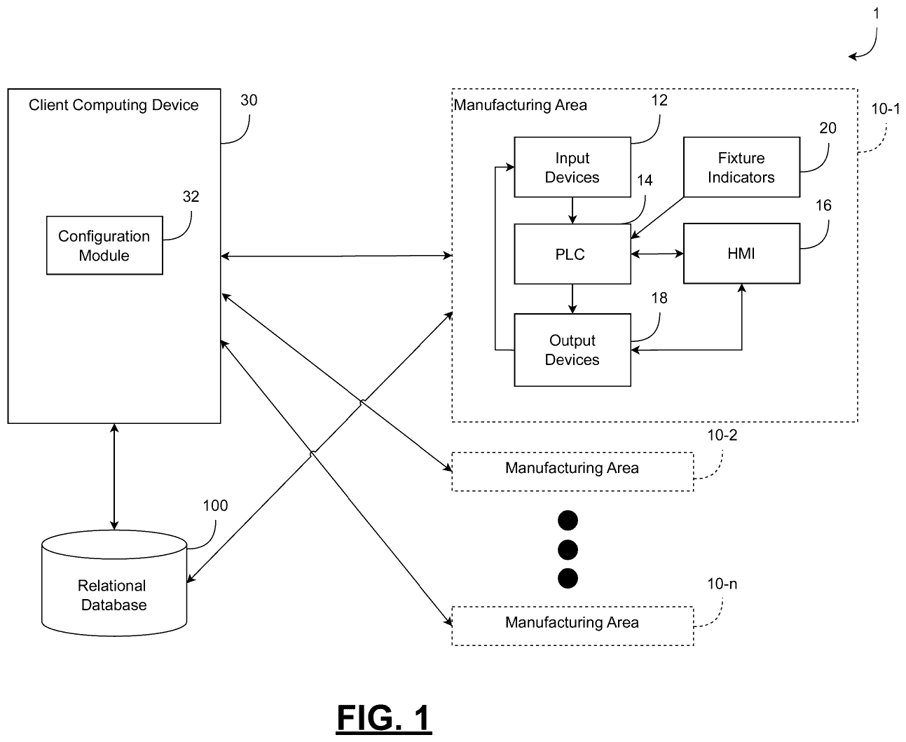

Referring to FIG. 1, a manufacturing environment 1 is provided and generally includes manufacturing areas 10-1, 10-2, . . . 10-n (collectively referred to hereinafter as “manufacturing areas 10”), a client computing device 30, and a relational database 100. It should be readily understood that any one of the components of the manufacturing environment 1 can be provided at the same location or distributed at different locations (e.g., via one or more edge computing devices) and communicably coupled accordingly (e.g., the components are provided at the same location and are coupled based on a structured query language (SQL) protocol). In one embodiment, the components of the manufacturing environment 1 are communicably coupled using known wired and/or wireless communication protocols (e.g., a Bluetooth® protocol, a cellular protocol, a wireless fidelity (Wi-Fi) protocol, a near-field communication (NFC) protocol, an ultra-wideband (UWB) protocol, etc.).

In one embodiment, each of the manufacturing areas 10 may be workspaces in which a respective manufacturing process is performed. As an example, the manufacturing areas 10 may be provided by caged or uncaged areas having a fence or other containment-like structure. As another example, the manufacturing areas 10 may be mobile platforms configured to move to various parts of the manufacturing environment 1 (e.g., a manufacturing facility). Each of the manufacturing areas 10 includes input devices 12, a PLC 14, an HMI 16, output devices 18, and fixture indicators 20.

The input devices 12 may include any type of device that is configured to generate and transmit state data to the PLC 14. As used herein, “state data” refers to quantitative data or qualitative data that represents an operational, physical, chemical, or electrical characteristic of a component within the manufacturing environment 1, such as quantitative or qualitative data output by the output devices 18. As an example, the input devices 12 may include various sensors, such as an image sensor (e.g., a two-dimensional or three-dimensional (3D) camera, an infrared sensor, a radar scanner, a laser scanner, and/or a light detection and ranging (LIDAR) sensor), a robot sensor (e.g., an accelerometer, a gyroscope, a magnetometer, a velocity sensor, and/or a torque sensor), location sensors (e.g., a global navigation satellite system (GNSS) sensor), acoustic sensors, temperature sensors, vibration sensors, presence sensors, and/or pressure sensors. As another example, the input devices 12 may include controllers that are associated with the output devices 18 and that are configured to output controller data (as the state data), such as robot controllers, manufacturing transformation machine controllers, and/or other controllers within the manufacturing area 10.

The output devices 18 may include any type of device that is configured to receive control data from the PLC 14. In some embodiments, the output devices 18 may be associated with respective input devices 12. As an example, the output devices may include various objects of the manufacturing area 10, such as a mobile system (e.g., mobile robots, mobile workstations, drones, automated guided vehicles, etc.), a fixed system (e.g., a stationary robot, a conveyor system, fixtures, etc.), a manufacturing transformation machine (e.g., a machining tool, a burning/welding machine, a computer numerical control (CNC) machine, a chemical machining tool, an electrical machining tool, etc.), and/or a workpiece.

The fixture indicators 20 may include sensors (e.g., resistive pressure sensors, capacitive pressure sensors, piezoelectric sensors, among others) that are disposed on a fixture in the given manufacturing area 10 and are configured to output a signal indicating an alignment between a workpiece and a fixture. Additional details regarding the fixture indicators 20 are provided below.

The PLC 14 is configured to control the operation of the output devices 18 based on the state data obtained from the input devices 12. As an example, the PLC 14 is configured to set one or more parameters of a manufacturing transformation performed by the manufacturing transformation machine (as the output device 18) and control the manufacturing transformation based on at least the setpoint parameters. To perform the functionality described herein, the PLC 14 may include a processor configured to execute instructions stored in a NCRM, such as a random access memory and a read-only memory, input/output interface modules to interface with the input and output devices 12, 18 and the HMI 16, and/or other known modules for performing the functionality described herein. The HMI 16 (e.g., a touchscreen display, monitor, among others) may include devices that enable an operator to generate inputs that cause the PLC 14 to perform the functionality described herein (e.g., mouse, keyboard, user-selectable graphical user interface (GUI) elements, among others).

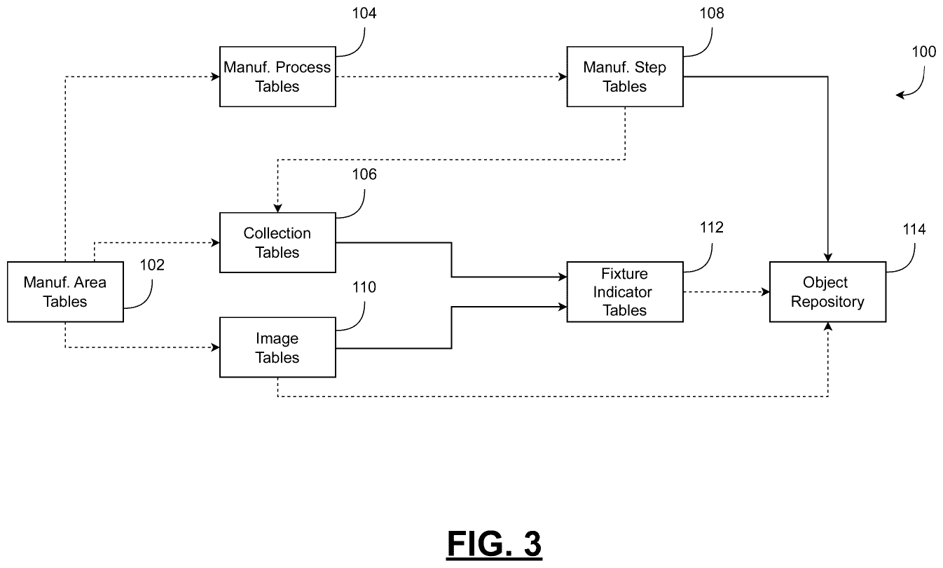

In one embodiment, the relational database 100 includes a plurality of relational database tables having logical relationships that are based on primary and foreign keys. The primary and foreign keys collectively represent various aspects of the manufacturing environment 1, as described below in further detail. As used herein, “primary key” refers to a set of columns in a table whose values uniquely identify a row in the table (e.g., an identification number) or vice versa, and “foreign key” refers to a set of columns in a table whose values correspond to the values of the primary key in another table. Additional details of the relational database 100 are described below with reference to FIG. 3.

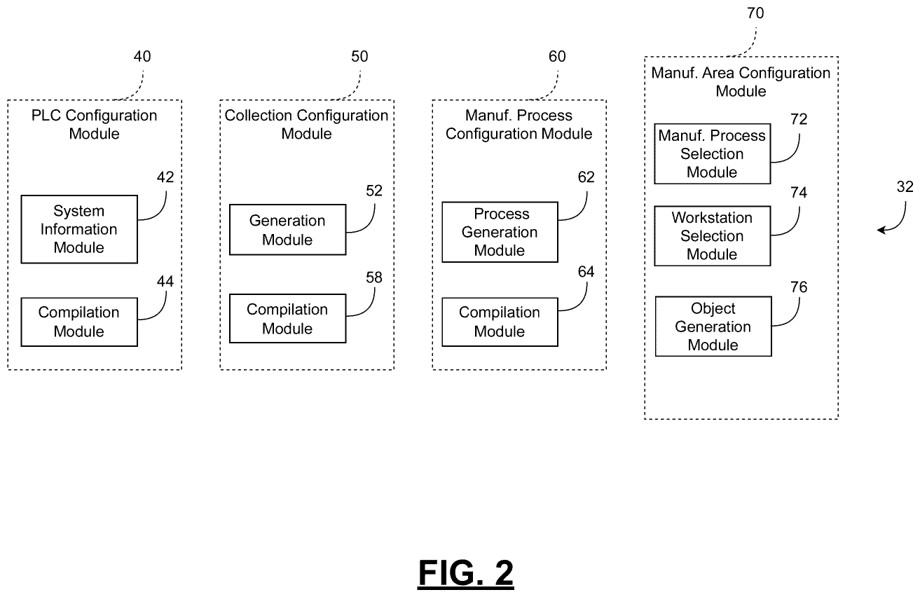

In one embodiment, the client computing device 30 includes a configuration module 32. Referring to FIGS. 1-2, the configuration module 32 includes a PLC configuration module 40, a collection configuration module 50, a manufacturing process configuration module 60, and a manufacturing area configuration module 70.

The PLC configuration module 40 includes a system information module 42 and a compilation module 44. The system information module 42 is configured to define at least one area parameter associated with a respective manufacturing area 10 based on an input received by the client computing device 30 (e.g., a manual input by an operator and/or a simulation file that defines the at least one area parameter). As used herein, “area parameter” refers to quantitative or qualitative data that represents a steady state, constant, or fixed operational, physical, chemical, and/or electrical characteristic of the manufacturing area 10. As an example, the area parameter may include, but is not limited to, a workspace parameter and/or a parameter of the output devices 18 (i.e., an output device parameter). The workspace parameter may indicate a dimension of the corresponding manufacturing area (e.g., an area, a perimeter, and/or a volume) and/or manufacturing area type (e.g., a manufacturing transformation area, an inspection area, a workpiece loading/unloading area, among other types of areas within the manufacturing environment 1). When the input devices 12 include one or more proximity sensors, the output device parameter may indicate a sensor arrangement (e.g., a location and/or number of proximity sensors) within the manufacturing area and/or the type of proximity sensors. When the input devices 12 include a robot, the output device parameter may indicate a type of robot (e.g., a fixed, moveable, and/or autonomous robot), a size of the robot (e.g., a length, width, and/or height), an operating range of the robot (e.g., an area, perimeter, and/or volume of the space in which the robot occupies during operation), and/or a degree of freedom of the robot. When the input device 12 include other types of objects, the output device parameter may indicate an object type (e.g., a machine, a conveyor, a fixture, a motor, an actuator, an interlock, etc.), an object size, an operational characteristic, and/or a location of the object within the manufacturing area 10.

In one embodiment, the system information module 42 generates the area parameters as a relational database table, which are collectively illustrated as manufacturing area tables 102 in FIG. 3. One or more manufacturing area tables may be respectively generated for each manufacturing area 10. The compilation module 44 is configured to store the manufacturing area tables in the relational database 100.

The collection configuration module 50 includes a generation module 52 and a compilation module 58. The generation module 52 is configured to generate a plurality of OOP-based collections (hereinafter referred to as “collections” and illustrated as collection tables 106 in FIG. 3) based on state data associated with the manufacturing area and at least one of the manufacturing area tables 102. In one embodiment, the collections are relational database tables, but it should be understood that other types of collections may be included in other embodiments. The generation module 52 may generate the collections based on inputs received by the client computing device 30. In an example embodiment of generating a collection, the generation module 52 selects one of the manufacturing area tables 102 associated with a given manufacturing area 10 and assigns collection parameters (e.g., collection prerequisites, collection commands, and collection terminations). As used herein, “collection commands” refer to PLC instructions to be executed by the PLC 14 when collection prerequisites are satisfied, and “collection prerequisites” refer to state data values of other collections/collection tables 106 that must be satisfied prior to executing the PLC instructions of the given collection. “Collection terminations” refer to state data values of the given collection/collection table 106 that must be satisfied as defined by the collection prerequisite of another collection. As a more specific example, for a given manufacturing area 10, the generation module 52 generates a plurality of collections describing threshold state values of an operational characteristic of a robot (e.g., the output device 18) that must be satisfied to execute a first set of PLC instructions and to transition to another collection.

In one embodiment and referring to FIGS. 2-3, the compilation module 58 is configured to store the collections in the relational database 100 (as indicated by collection tables 106 in FIG. 3). The compilation module 58 logically couples each of the collection tables 106 to the manufacturing area tables 102 such that a one-to-many relationship is formed between each of the collection tables 106 and respective manufacturing area tables 102 (as indicated by the dashed line therebetween in FIG. 3). That is, each manufacturing area table 102 may be associated with multiple collection tables 106.

Referring to FIG. 2, the manufacturing process configuration module 60 includes a process generation module 62 and a compilation module 64. The process generation module 62 is configured to generate a plurality of manufacturing processes to be performed in the manufacturing environment 1. In one embodiment, the manufacturing processes are defined as relational database tables, but it should be understood that other types of data structures may be included in other embodiments. The process generation module 62 may generate the manufacturing processes based on inputs received by the client computing device 30. In an example embodiment of generating the manufacturing process, the process generation module 62 selects one of the manufacturing area tables 102 associated with a given manufacturing area 10, defines one or more steps of the manufacturing processes performed at the given manufacturing area 10, and step parameters of each step (e.g., step prerequisites, step commands, and step terminations). As used herein, “step commands” refer to a given set of PLC instructions to be executed by the PLC 14 when step prerequisites are satisfied, and “step prerequisites” refer to a preceding set of PLC instructions that must be executed prior to executing the given set of PLC instructions. “Step terminations” refer to portions of the given set of PLC instructions that indicate the PLC 14 is ready to transition to a subsequent step of PLC instructions. As a more specific example, for a given manufacturing area 10, the process generation module 62 generates a manufacturing process corresponding to operating a robot (e.g., the output device 18), and for each step of the robot operation, step parameters are provided to control the operation of the robot and to properly transition between various steps of the robot operation.

In one embodiment and referring to FIGS. 2-3, the compilation module 64 is configured to store the manufacturing processes and the steps thereof in the relational database 100 (as indicated by manufacturing process tables 104 and the manufacturing steps table 108 in FIG. 3). The compilation module 64 logically couples each of the manufacturing process tables 104 to the manufacturing area tables 102 such that a one-to-many relationship is formed between each of the manufacturing process tables 104 and the manufacturing area tables 102. That is, each manufacturing area table 102 may be associated with multiple manufacturing process tables 104. Furthermore compilation module 64 logically couples each of the manufacturing process tables 104 to the manufacturing process steps table 108 such that a one-to-many relationship is formed between each of the manufacturing process tables 104 and the manufacturing process step tables 108. That is, each manufacturing process table 104 may be associated with multiple manufacturing process step tables 108.

Referring to FIG. 2, the manufacturing area configuration module 70 includes a manufacturing process selection module 72, a workstation selection module 74, and an object generation module 76. The manufacturing process module 72 is configured to select a target/given manufacturing area 10, a target manufacturing process from among the one or more manufacturing processes performed in the given manufacturing area 10, and a step of the target manufacturing process based on an input received by the client computing device 30.

For each step of the target manufacturing process, and referring to FIGS. 2-3, the workstation selection module 74 selects an image stored in image tables 110. In one embodiment, the images of the image tables 110 represent workpieces, fixtures, input devices 12, output devices 18, and/or other objects within the selected manufacturing area 10. In some embodiments, the images stored in the image tables 110 is identified by a given primary key of the image tables 110 and is stored as a row in the image tables 110. The images may be obtained from an image sensor, a virtual representation of the various objects in the manufacturing area 10 (e.g., a computer-aided design (CAD) model or other simulation file). The images of the image table 110 may be represented as, for example, scalable vector graphic (SVG) files or other types of suitable vector graphic files.

In one embodiment, the image tables 110 are logically coupled to the manufacturing area tables 102 such that a one-to-many relationship is formed between each of the image tables and respective manufacturing area tables 102 (as indicated by the dashed line therebetween in FIG. 3). That is, each manufacturing area table 102 may be associated with multiple image tables 110.

For each step of the target manufacturing process, the workstation selection module 74 selects one or more images from the fixture indicator tables 112 that represent the fixture indicators 20 associated with the selected images from the image tables 110. The selection may indicate an ID of the fixture indicators 20, the number of fixture indicators 20, the types of fixture indicators 20, location of fixture indicators 20 (e.g., a 2D and/or 3D location, a predefined location, and/or a dynamically defined location), the arrangement of fixture indicators 20, and/or other characteristics associated with the fixture indicators. The fixture indicators 20 stored in the fixture indicator tables 112 may be represented as, for example, SVG files or other types of vector graphic files.

The fixture indicator tables 112 are logically coupled to the image tables 110 such that a one-to-one relationship is formed between each of the fixture indicator tables 112 and image tables 110 (as indicated by the solid line therebetween in FIG. 3). Similarly, the fixture indicator tables 112 are logically coupled to the collection tables 106 such that a one-to-one relationship is formed between each of the fixture indicator tables 112 and collection tables 106 (as indicated by the solid line therebetween in FIG. 3). That is, each fixture indicator table 112 is associated with only one of the image tables 110 and only one of the collection tables 106.

For each step of the target manufacturing process, the workstation selection module 74 assigns at least one of the collections of the collection tables 104 to the selected images from the image tables 110 and the fixture indicator tables 112 based on a parameter of the given step (i.e., the step parameter). That is, the client computing device 30 may receive an input corresponding to a selection of a collection having collection prerequisites, collection commands, and collection terminations that correspond to the given step of the manufacturing process.

The object generation module 76 is configured to generate, for each step of the target manufacturing process, an object from among a plurality of objects stored in an object repository 114 of the relational database 100 based on the selected image of the image tables 110, the selected fixture indicator(s) of the fixture indicator tables 112, and the selected collection. To perform the functionality described herein, the object generation module 76 is configured to perform OOP routines and, more specifically, various relational operations on the selected image, fixture indicators, and collection (e.g., a selection operation, a projection operation, a set-difference operation, a union operation, and/or a cross-product/cartesian product operation) to thereby selectively combine and store these elements as an object in the object repository 114.

When the object generation module 76 generates each of the objects of the object repository 114, the PLC 14 is configured to perform the PLC mapping routine to map the objects to the addresses/variables of the NCRM of the PLC 14. The PLC mapping routine may be performed by manually associating addresses/variables to the objects or by automatically associating addresses/variables that are identified during a scanning routine of the NCRM of the PLC to the objects. By mapping the objects of the object repository 114 to the PLC 14, the accuracy in which complex operations and data operations performed by the PLC 14 increases, as the PLC can execute syntax from graphical and textual languages identified by the international standard IEC 61131 while achieving the benefits of OOP-based programming languages (e.g., abstraction, encapsulation, inheritance, and polymorphism).

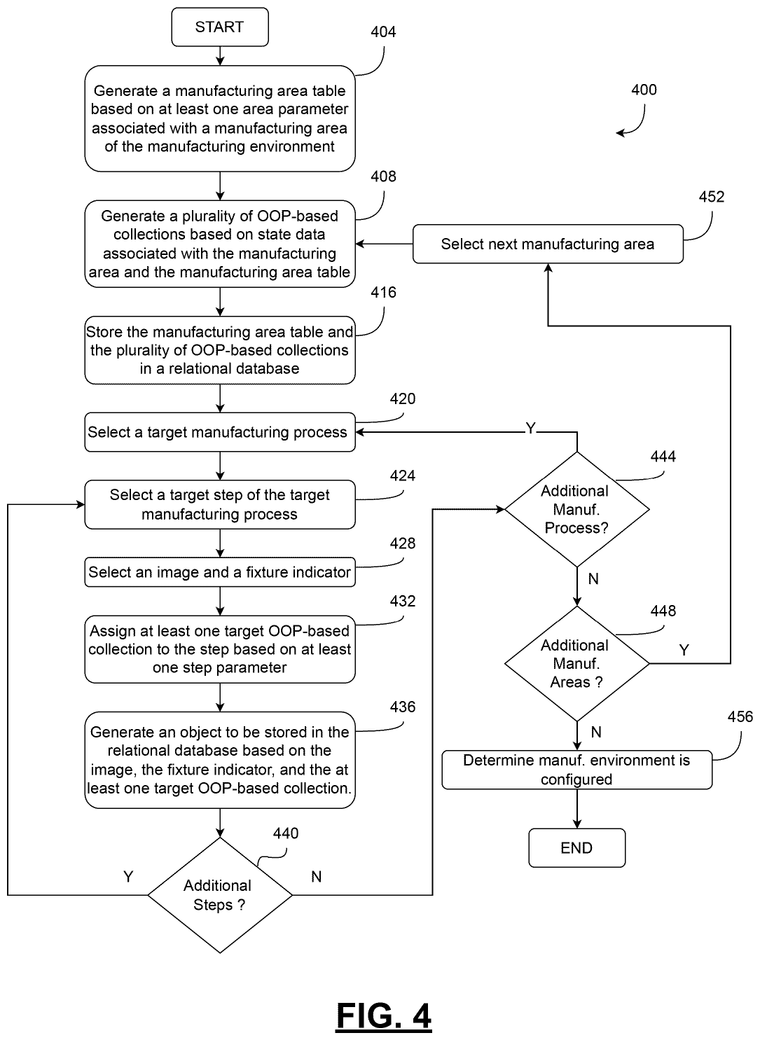

Referring to FIG. 4, a flowchart illustrating a routine 400 for defining a plurality of manufacturing processes of the manufacturing environment 1 is shown. At 404, the client computing device 30 generates a manufacturing area table 102 based on at least one area parameter associated with a manufacturing area 10 of the manufacturing environment 1. At 408, the client computing device 30 generates a plurality of OOP-based collections (e.g., the collection tables 106) based on state data associated with the manufacturing area 10 and the manufacturing area table 102. At 416, the client computing device 30 stores the manufacturing area table and the plurality of OOP-based collections in the relational database 100.

At 420, the client computing device 30 selects a target manufacturing process from among the plurality of manufacturing processes and selects a target step thereof at 424. At 428, the client computing device 30 selects, based on the manufacturing area 10, an image and a fixture indicator that are stored in the relational database 100. At 432, the client computing device 30 assigns at least one target OOP-based collection from among the plurality of OOP-based collections to the step based on at least one step parameter associated with the step. At 436, the client computing device 30 generates an object from among a plurality of objects stored in the relational database 100 based on the image, the fixture indicator, and the at least one target OOP-based collection.

At 440, the client computing device 30 determines whether objects for additional steps of the manufacturing process are needed. If so, the routine 400 proceeds to 424; otherwise, the routine 400 proceeds to 444, where the client computing device 30 determines whether objects for additional manufacturing processes of the given manufacturing area 10 are needed. If so, the routine 400 proceeds to 420; otherwise, the routine 400 proceeds to 448, where the client computing device 30 determines whether additional manufacturing areas 10 need to be configured. If so, the routine 400 proceeds to 452, where the client computing device 30 selects the next manufacturing area 10 and proceeds to 408. Otherwise, the routine 400 proceeds to 456, where the client computing device 30 determines that the manufacturing environment 1 is configured.

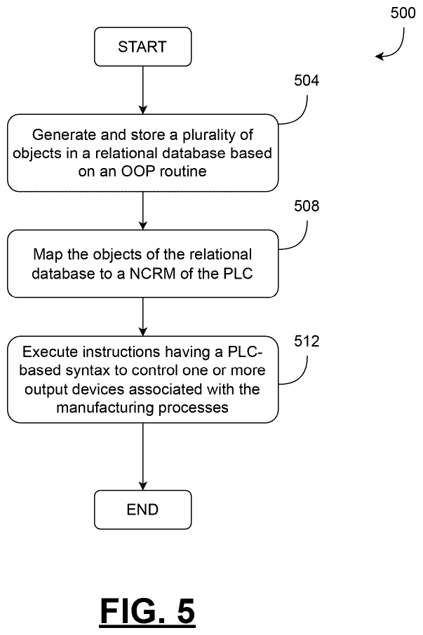

Referring to FIG. 5, a flowchart illustrating a routine 500 for controlling a plurality of manufacturing processes of the manufacturing environment 1 is shown. At 504, the client computing device 30 generates and stores a plurality of objects in the relational database 100 based on an OOP routine (e.g., the client computing device 30 performs routine 400 described above with reference to FIG. 4). At 508, the PLC 14 maps the plurality of objects of the relational database 100 to the NCRM of the PLC 14. At 512, the PLC 14 executes instructions having a PLC-based syntax to control one or more output devices 18 associated with the plurality of manufacturing processes, where the control of the one or more output devices 18 is based on the plurality of objects.

The terminology used in the description of the disclosure herein is for the purpose of describing particular embodiments only and is not intended to be limiting of the disclosure. As used in the description of the disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the phrase at least one of A, B, and C should be construed to mean a logical (A OR B OR C), using a non-exclusive logical OR, and should not be construed to mean “at least one of A, at least one of B, and at least one of C.”

The present disclosure has been described herein with reference to flowchart and/or block diagram illustrations of methods, systems, and devices in accordance with exemplary embodiments of the present disclosure. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term module may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality, such as, but not limited to, transceivers, routers, input/output interface hardware, among others; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term code, as used herein, may include software, firmware, and/or microcode, and may refer to computer programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As an example, source code may be written using syntax from languages including C, C++, C#, Objective-C, Swift, Haskell, Go, SQL, R, Lisp, Java®, Fortran, Perl, Pascal, Curd, OCaml, Javascript®, HTML5 (Hypertext Markup Language 5th revision), Ada, ASP (Active Server Pages), PUP (PUP: Hypertext Preprocessor), Scala, Eiffel, Smalltalk, Erlang, Ruby, Flash®, Visual Basic®, Lua, MATLAB, SIMULINK, and Python®.

The present disclosure is described with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Thus, variations that do not depart from the substance of the disclosure are intended to be within the scope of the disclosure. Such variations are not to be regarded as a departure from the spirit and scope of the disclosure. The scope of the present disclosure is defined by the attached claims.

What is claimed is:

1. A method for defining a plurality of manufacturing processes of a manufacturing environment using an object-oriented programming (OOP) routine, the method comprising:
generating a manufacturing area table based on at least one area parameter associated with a manufacturing area of the manufacturing environment;
generating a plurality of OOP-based collections based on state data associated with the manufacturing area and the manufacturing area table;
storing the manufacturing area table and the plurality of OOP-based collections in a relational database;
selecting a target manufacturing process from among the plurality of manufacturing processes;
for each step of the target manufacturing process:
selecting, based on the manufacturing area, an image and a fixture indicator that are stored in the relational database;
assigning at least one target OOP-based collection from among the plurality of OOP-based collections to the step based on at least one step parameter associated with the step; and
generating an object from among a plurality of objects stored in the relational database based on the image, the fixture indicator, and the at least one target OOP-based collection.

2. The method of claim 1, wherein the manufacturing area table, the plurality of OOP-based collections, and the object are generated by a client computing device.

3. The method of claim 2, further comprising controlling, by a programmable logic controller, the target manufacturing process.

4. The method of claim 1, wherein the at least one area parameter comprises at least one of a workspace parameter and an output device parameter.

5. The method of claim 4, wherein the output device parameter comprises at least one of a type of a robot, a size of the robot, an operating range of the robot, and a degree of freedom of the robot.

6. The method of claim 4, wherein the workspace parameter comprises at least one of a manufacturing area dimension and a manufacturing area type.

7. The method of claim 4, wherein the output device parameter comprises at least one of an object type, an object size, and an object location within the manufacturing area.

8. The method of claim 4, wherein the at least one area parameter is based on a programmable logic controller simulation file.

9. The method of claim 1, wherein the state data comprises at least one of sensor data associated with a sensor of the manufacturing environment and controller data associated with a programmable logic controller of the manufacturing environment.

10. The method of claim 1, further comprising generating and storing at least one additional table in the relational database, wherein the at least one additional table comprises at least one of a manufacturing process table, a collections table, and an image table.

11. The method of claim 10, wherein the manufacturing area table and the at least one additional table define a one-to-many relationship.

12. The method of claim 11, further comprising generating and storing a manufacturing step table in the relational database, wherein:
the at least one additional table comprises the manufacturing process table; and
the manufacturing process table and the manufacturing step table define a one-to-many relationship.

13. The method of claim 11, further comprising generating and storing a fixture indicator table in the relational database, wherein:
the at least one additional table comprises the collections table and the image table;
the fixture indicator table and the collections table define a one-to-one relationship; and
the fixture indicator table and the image table define the one-to-one relationship.

14. The method of claim 13, wherein the fixture indicator table indicates an arrangement of at least one fixture indicator of the manufacturing environment.

15. The method of claim 11, wherein:
the at least one additional table comprises the collections table; and
the manufacturing area table and the collections table define a one-to-many relationship.

16. The method of claim 1, wherein the at least one step parameter comprises at least one of a prerequisite collection parameter, a command parameter, and a completion parameter.

17. The method of claim 1, wherein generating the object further comprises performing a relational operation on the image, the fixture indicator, and the at least one target OOP-based collection.

18. A system for defining a plurality of manufacturing processes of a manufacturing environment using an object-oriented programming (OOP) routine, the system comprising:
a plurality of processors; and
a plurality of nontransitory computer-readable mediums comprising instructions that are executable by the plurality of processors, wherein the instructions comprise:
generating a manufacturing area table based on at least one area parameter associated with a manufacturing area of the manufacturing environment;
generating a plurality of OOP-based collections based on state data associated with the manufacturing area and the manufacturing area table;
storing the manufacturing area table and the plurality of OOP-based collections in a relational database;
selecting a target manufacturing process from among the plurality of manufacturing processes;
for each step of the target manufacturing process:
selecting, based on the manufacturing area, an image and a fixture indicator that are stored in the relational database;
assigning at least one target OOP-based collection from among the plurality of OOP-based collections to the step based on at least one step parameter associated with the step; and
generating an object from among a plurality of objects stored in the relational database based on the image, the fixture indicator, and the at least one target OOP-based collection.

19. The system of claim 18, wherein:
the at least one area parameter comprises at least one of a workspace parameter and an output device parameter;
the output device parameter comprises at least one of a type of a robot, a size of the robot, an operating range of the robot, and a degree of freedom of the robot;
the workspace parameter comprises at least one of a manufacturing area dimension, a manufacturing area type, an object type, an object size, and an object location within the manufacturing area; and
the state data comprises at least one of sensor data associated with a sensor of the manufacturing environment and controller data associated with a programmable logic controller of the manufacturing environment.

20. The system of claim 18, wherein:
the instructions further comprise generating and storing at least one additional table in the relational database, wherein the at least one additional table comprises at least one of a manufacturing process table, a collections table, an image table, and a fixture indicator table; and
the at least one step parameter comprises at least one of a prerequisite collection parameter, a command parameter, and a completion parameter; and
generating the object further comprises performing a relational operation on the image, the fixture indicator, and the at least one target OOP-based collection.
